(19) United States
(12) Patent Application Publication
(10) Pub. No.: US 2019/0053879 A1
(43) Pub. Date: Feb. 21, 2019

(54) SEAL FOR REMOVABLE AND ADJUSTABLE DENTAL PROSTHESIS AND METHODS OF OPERATION THEREOF

(71) Applicant: Rodo Medical, Inc., San Jose, CA (US)

(72) Inventors: Jong Gil Park, Santa Clara, CA (US); Young Seo, Sunnyvale, CA (US)

(73) Assignee: Rodo Medical, Inc., San Jose, CA (US)

(21) Appl. No.: 15/678,482

(22) Filed: Aug. 16, 2017

(51) Int. Cl. A61C 8/00

(52) U.S. Cl. CPC A61C 8/005; A61C 13/0003; A61C 8/0022

(57) ABSTRACT

Apparatus and methods for adjustably retaining a dental prosthesis are disclosed. In one variation, a securement assembly includes an abutment assembly comprising an upper abutment portion configured to extend beyond the gingiva of a patient. The upper abutment portion can have an abutment ledge and the abutment ledge can be defined by a receiving groove. The securement assembly can also include a coping attached to the abutment assembly. The coping can have a coping base. A seal can be positioned in the receiving groove and in between at least the abutment ledge and the coping base. The seal can elastically deform to allow the coping to translate relative to the abutment assembly.

### FIELD OF THE INVENTION

The present invention relates to methods and apparatus for adjustably retaining a dental prosthesis in an oral cavity. More particularly, the present invention relates to methods and apparatus for improving the engagement between an oral appliance and an abutment assembly when the oral appliance is removably coupled to the abutment assembly.

### BACKGROUND OF THE INVENTION

The use of dental prostheses to replace missing or damaged teeth is commonplace. Typically, artificial roots, or implants, are implanted into the bone of the patient's jaw and are used to provide structural support to an intermediate abutment. One or more artificial replacement teeth or crowns are then fastened to the abutment typically by cement or screws.

FIGS. 1A to 1D illustrate partial cross-sectional side views of one example of a typical crown being implanted within a mouth of a patient. Depending upon the number of teeth to be replaced, one or more holes may be bored within the bone of the jaw. As shown in FIG. 1A, a portion of the patient's gums or gingiva 14 may be cut open to expose the underlying bone 10, e.g., maxilla or mandible, into which a drill bit 16 may be used to bore open a hole 12. An anchoring dental implant 18, optionally threaded, may be implanted within the hole 12 and covered by gingiva 14 to allow for healing and for the implant 18 to take hold within the bone 10, as shown in FIG. 1B.

Once the implant 18 has been desirably positioned within bone 10, an abutment assembly 20 may be securely attached to implant 18, e.g., by a threaded pin 22 coupling to an implant receiving well 26 defined within implant 18 such that abutment 24, which defines a portion projecting through gingiva 14, as shown in FIG. 1C. With abutment assembly 20 secured to implant 18, an oral appliance 28, such as a crown, which defines an appliance opening 30 may be secured upon abutment 24 by utilizing a number of securement mechanisms, such as cement or a fastener such as a screw. Other securement mechanisms have also included interference fitting, such as with a cross-bar or O-ring type attachment, magnets, etc.

Unlike a patient's natural teeth, an oral appliance (e.g., a crown, bridge, or dentures) fixedly attached to an abutment assembly does not allow for the type of physiological movements exhibited by natural teeth. For example, Picton showed that vertical tooth movement, or the displacement of a tooth in a plane perpendicular to the occlusal plane, occurred in test subjects applying a known biting load to their natural teeth. See Picton, D. C. A. Vertical Movement of Cheek Teeth During Biting, Archives of Oral Biology, vol. 8, pp. 109-118, 1963. However, dental prostheses are still subject to the same compressive and shear forces as natural teeth. As such, an oral appliance which has been fixedly attached to an abutment (e.g., by cement) can often feel unnatural and lead to discomfort for the patient. Moreover, such compressive forces can often damage either the oral appliance or the abutment assembly over time.

Plastic bumpers or gaskets have been offered as a way to preserve the contact region between the oral appliance and the abutment assembly. However, such plastic bumpers or gaskets often plastically deform over time and, as a result, lose their effectiveness.

Accordingly, there exists a need for devices and methods which can improve the engagement between an oral appliance and an abutment assembly in the mouth of a patient. Such a solution should also allow the dental prosthesis to mimic the vertical movement of natural teeth and preserve the contact region between the oral appliance and the abutment assembly.

### SUMMARY OF THE INVENTION

Assemblies and methods for adjustably retaining a dental prosthesis are disclosed. In addition, the assemblies and methods described herein facilitate the engagement of an oral appliance, such as a crown, bridge or dentures, with an abutment assembly when the oral appliance is removably coupled to the abutment assembly. In utilizing the assemblies and methods described herein, an anchoring implant can be bored into the bones within the mouth of the patient to provide structural support for an abutment assembly. Moreover, the implants and abutment assemblies described herein can be utilized in any number of locations within the mouth of the patient, for instance, along the maxilla or mandible or other locations within the body which may benefit from an adjustable or removable abutment assembly having a seal as described herein. Additionally, although some of the examples illustrate the placement and/or removal of crowns, various other prostheses for placement within or along the patient dentition may be utilized with the devices described herein and are not intended to be limited to use with crowns.

A securement assembly for adjustably retaining a dental prosthesis is disclosed. The securement assembly can include an abutment assembly comprising an upper abutment portion configured to extend beyond the gingiva of a patient. The upper abutment portion can have an abutment ledge and the abutment ledge can be defined by a receiving groove. The securement assembly can include a coping attached to the abutment assembly. The coping can comprise a coping base. The securement assembly can also include a seal positioned in the receiving groove and in between at least the abutment ledge and the coping base. The seal can elastically deform to allow the coping to translate relative to the abutment assembly while the coping is locked against the abutment assembly.

Another variation of the securement assembly can include an abutment assembly comprising an upper abutment portion configured to extend beyond the gingiva of a patient. The upper abutment portion can have an abutment ledge. The securement assembly can include a coping attached to the abutment assembly. The coping can have a coping base. An interior surface of the coping base can be defined by a receiving groove. The securement assembly can also include a seal positioned in the receiving groove and in between at least the abutment ledge and the coping base. The seal can be configured to elastically deform to allow the coping to translate relative to the abutment assembly while the coping is locked against the abutment assembly.

A method of adjustably retaining an oral appliance in an oral cavity is also disclosed. The method can include securing an abutment assembly comprising an upper abutment portion in an oral cavity of a patient such that the upper abutment portion extends beyond the gingiva of the patient. The upper abutment portion can have an abutment ledge and the abutment ledge can be defined by a receiving groove. The method can include positioning a seal in the receiving groove and coupling a sleeve comprising one or more locking flaps to the upper abutment portion. The method can also include placing the oral appliance upon the upper abutment portion such that the seal is positioned in between the abutment ledge and a coping attached to the oral appliance. The one or more locking flaps can project radially outward to lock the oral appliance to the abutment assembly.

### BRIEF DESCRIPTION OF THE DRAWINGS

FIGS. 1A to 1D illustrate partial cross-sectional profiles of an implant placed in an oral cavity of a patient and attaching an oral appliance thereto.

FIG. 2 illustrates an exploded view of a variation of a prosthesis assembly.

FIG. 3A illustrates a cross-sectional side view of a variation of the prosthesis assembly prior to attachment of the oral appliance.

FIG. 3B illustrates a cross-sectional side view of a variation of the prosthesis assembly with the oral appliance attached.

FIG. 4A illustrates a variation of the prosthesis assembly with a seal positioned on an abutment assembly.

FIG. 4B illustrates a cross-sectional side view of the prosthesis assembly of FIG. 4A with the coping placed on the abutment assembly.

FIG. 5A illustrates another variation of the prosthesis assembly with the seal positioned in the coping.

FIG. 5B illustrates a cross-sectional side view of the prosthesis assembly of FIG. 5A with the coping placed on the abutment assembly.

FIG. 5C illustrates yet another variation of the prosthesis assembly having an implant with an implant ledge and the seal positioned in the coping.

FIG. 5D illustrates the prosthesis assembly of FIG. 5C with the abutment assembly positioned within the receiving well of the implant.

FIGS. 6A and 6B illustrate cross-sectional side views of a variation of the oral appliance mimicking the physiological movements of natural teeth on the abutment assembly.

FIG. 7 illustrates a close-up of a cross-sectional view of a variation of the seal in a receiving groove.

FIG. 8A illustrates a perspective view of a variation of a seal.

FIG. 8B illustrates a cross-section of the variation of the seal taken along line A-A shown in FIG. 8A.

FIG. 8C illustrates a cross-section of another variation of the seal.

FIG. 8D illustrates a cross-section of yet another variation of the seal.

FIG. 9A illustrates a variation of an angled abutment assembly with a seal positioned on the angled abutment assembly.

FIG. 9B illustrates another variation of an angled abutment assembly with a seal positioned on the angled abutment assembly.

FIG. 10 illustrates a variation of a two-piece abutment assembly with a seal positioned on the two-piece abutment.

FIGS. 11A to 11F illustrate a method of placing and removing a crown from a variation of an abutment assembly with a seal positioned on the abutment assembly.

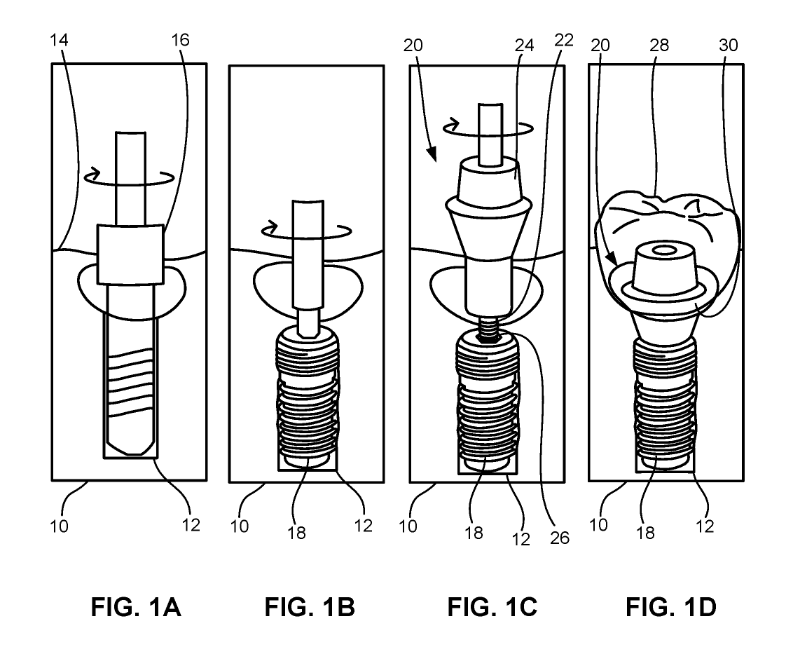

### DETAILED DESCRIPTION OF THE INVENTION

In positioning and securing an oral appliance, such as a crown, bridge, or denture, within the mouth of a patient, the retaining assemblies described herein allow not only for secure attachment but also for adjustment of the oral appliance along the patient's dentition. The assemblies and devices described also provide for mechanisms and methods to facilitate the engagement between the oral appliance and an abutment assembly in the mouth of a patient. In utilizing the abutment assemblies described herein, any number of typical anchoring implants may be bored into the bones within the mouth of the patient to provide for the structural support of the abutment assembly. Moreover, the implants and abutment assemblies described herein may be utilized in any number of locations within the mouth of the patient, for instance, along the maxilla or mandible or other locations within the body which may benefit from the assemblies and devices as described herein.

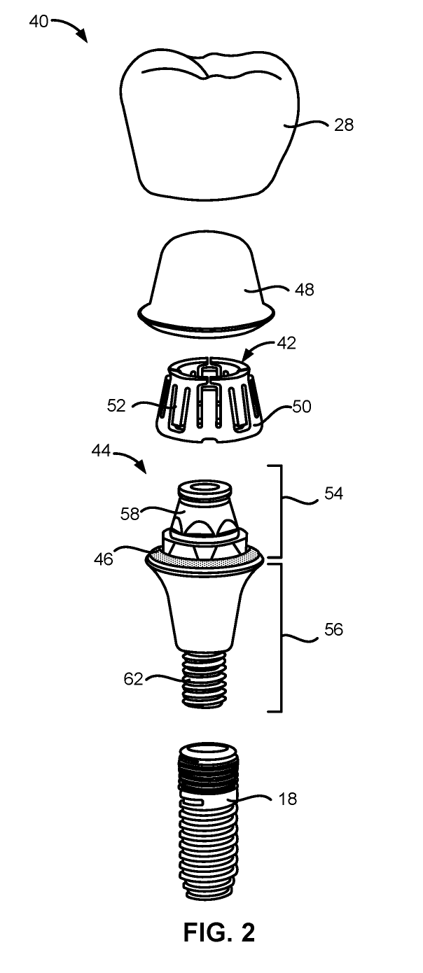

Turning now to FIG. 2, one example of a prosthesis assembly 40 is illustrated as having a sleeve 42, an abutment assembly 44, a seal 46, and a coping 48. The prosthesis assembly 40 can also include an oral appliance 28, such as a crown, a bridge, or dentures, the anchoring implant 18, or any combination thereof. The sleeve 42 can have a sleeve frame 50 and one or more locking flaps 52 which extend longitudinally along a lateral surface of the sleeve 42.

The abutment assembly 44 can include an upper abutment portion 54 and a lower abutment portion 56. The upper abutment portion 54 can have a frustum 58, an anti-rotation mechanism 60, or any combination thereof. The lower abutment portion 56 can have a threaded pin 62 for attaching to the anchoring implant 18. In another variation, the threaded pin 62 can be coupled to a pre-existing root of a patient's tooth, such as to a pulp chamber.

Portions of the abutment assembly 44 can be fabricated from any number of biocompatible materials, e.g., gold alloys, stainless steel, nickel-titanium alloys, etc., and can be sized for positioning along the patient's dentition. For instance, the abutment assembly 44 can have a diameter along its widest portion ranging from, e.g., 2 mm to 10 mm, and a length ranging from, e.g., 1 mm to 15 mm. These dimensions are exemplary and are not intended to be limiting. The abutment assembly 44 can be any of the abutments or abutment retaining assemblies disclosed in U.S. patent application Ser. No. 14/485,430, U.S. patent application Ser. No. 14/602,062, and U.S. patent application Ser. No. 15/337,905 and U.S. Pat. No. 8,047,844, U.S. Pat. No. 8,109,764, U.S. Pat. No. 8,317,515, U.S. Pat. No. 8,491,303, U.S. Pat. No. 8,221,118, U.S. Pat. No. 8,403,668, U.S. Pat. No. 8,651,864, U.S. Pat. No. 8,678,822, U.S. Pat. No. 8,845,329, and U.S. Pat. No. 9,168,111, the contents of which are herein incorporated by reference in their entireties.

The seal 46 can serve as a cushioning layer or interface between the coping 48 and the abutment assembly 44. The seal 46 can be fabricated from any number of biocompatible elastomers, e.g., silicone, polyurethane, poly(vinyl chloride), etc. The seal 46 will be discussed in more detail in the sections that follow.

The frustum 58 can be a segment of the upper abutment portion 54 having a frustoconical or tapered shape. The sleeve 42 can be positioned on the upper abutment portion 54 around the frustum 58 of the abutment assembly 44. The frustum 58 can receive the sleeve 42 when the sleeve 42 is curled into a tapered configuration. In one variation, the frustum 58 can have a smooth or unabraded surface. In another variation, the frustum 58 can have a rough or abraded surface. At least a part of the upper abutment portion 54 can extend beyond the gingiva 14 of the patient when the abutment assembly 44 is secured onto the anchoring implant 18.

The coping 48 can be a cap or covering serving as an accommodation or platform for the oral appliance 28. In the variation shown in FIG. 2, the coping 48 can be shaped substantially as a thimble or frustoconic having rounded edges. The oral appliance 28 can be attached to an outside surface of the coping 48 by a biocompatible adhesive such as cement. The inner surface of the coping 48 can be shaped or defined to accommodate fitting over or onto the upper abutment portion 54. As shown in FIG. 2, the inner surface of the coping 48 can also be shaped or defined to accommodate fitting over the sleeve 42 and the upper abutment portion 54.

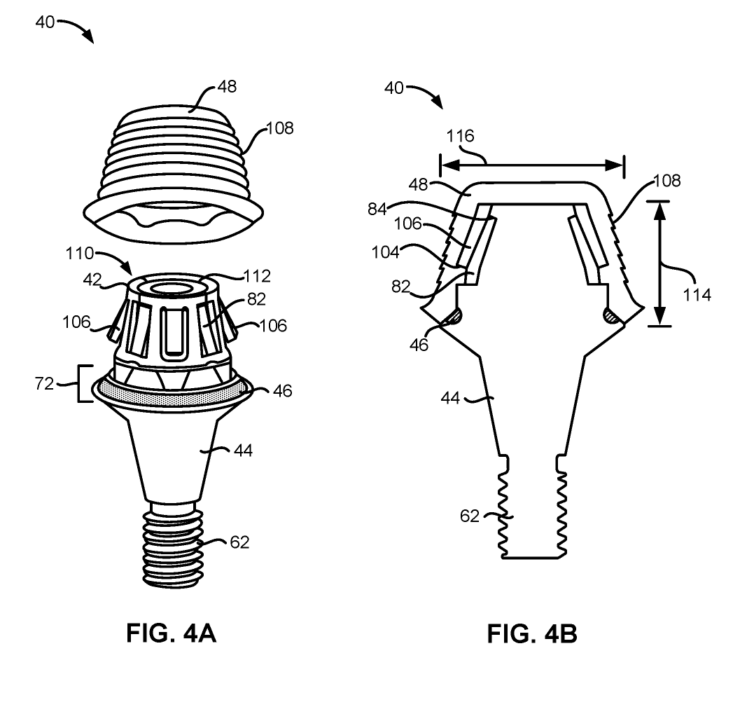

FIG. 2 illustrates a variation of the sleeve 42 of the prosthesis assembly 40 in a low-profile configuration. The sleeve 42 can be considered to be in the low-profile configuration when the locking flaps 52 are straightened or flush with respect to the lateral surface of the sleeve frame 50. In another variation, the sleeve 42 can be considered to be in the low-profile configuration when the locking flaps 52 do not project radially inward or outward relative to the lateral surface of the sleeve frame 50. In other variations, the sleeve 42 can be considered to be in the low-profile configuration when the locking flaps 52 project less radially inward or outward relative to the lateral surface of the sleeve frame 50 than the sleeve 42 in the locking configuration 110 (see FIG. 4A).

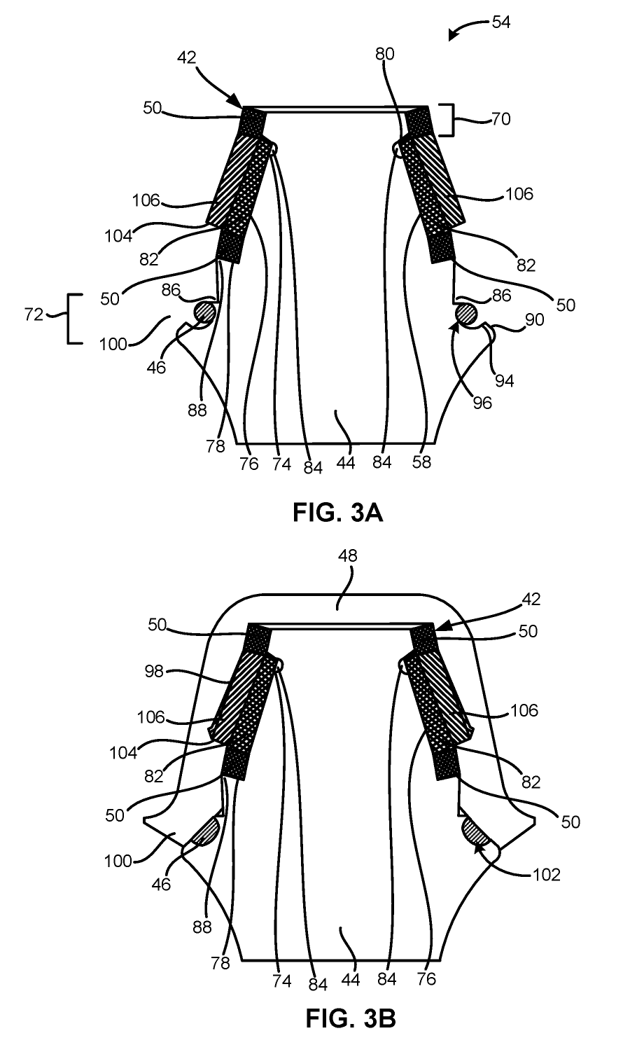

FIG. 3A illustrates a cross-sectional side view of a variation of the upper abutment portion 54 prior to placement or attachment of the oral appliance 28. The upper abutment portion 54 can comprise a cornice portion 70, the frustum 58, and an abutment ledge 72.

The frustum 58 can comprise a frustum top 74, a frustum surface 76, and a frustum base 78. The frustum surface 76 can be a lateral or side surface of the frustum 58. The frustum surface 76 can be in between the frustum top 74 and the frustum base 78.

The cornice portion 70 can be an overhang or annular portion protruding radially outward relative to the frustum surface 76. The cornice portion 70 can encompass one or more edges or surfaces of the upper abutment portion 54. As shown in FIG. 3A, the cornice portion 70 can include a chamfered edge 80. The chamfered edge 80 can be a beveled, pitched, or sloped edge of the cornice portion 70. The chamfered edge 80 can have a chamfer angle of between 10° and up to 80° relative to a transverse horizontal plane.

The chamfered edge 80 can act as a receiving surface for the ends or terminal portions of the locking flaps 52 of the sleeve 42. For example, the chamfered edge 80 can serve as a receiving surface for a plurality of locking flaps 52 projecting radially inward relative to the sleeve frame 50. The chamfered edge 80 can have locking flaps 52 of different lengths locked or pushing against the chamfered edge 80. The locking flaps 52 can lock against the chamfered edge 80 when the terminal ends of the locking flaps 52 push against or contact the chamfered edge 80 to prevent the sleeve 42 from being longitudinally displaced from the frustum 58 of the abutment assembly 44. The locking flaps 52 projecting radially inward relative to the lateral surface of the sleeve frame 50 can be referred to as the inward flaps 82.

The chamfered edge 80 can offer a surface aligned with the ends or terminal portions of the inward flaps 82. In other variations not shown in the figures but contemplated by this disclosure, the cornice portion 70 can include a flat or horizontal edge and the flat or horizontal edge can also act as a receiving surface for the ends or terminal portions of the inward flaps 82.

The frustum top 74 can adjoin a cornice undercut 84. The cornice undercut 84 can extend circumferentially around a perimeter of the frustum top 74. For example, the cornice undercut 84 can be a groove or indentation extending radially inward relative to the frustum surface 76.

The chamfered edge 80 can adjoin a portion of the cornice undercut 84. For example, the chamfered edge 80 can act as a transitional edge or surface between a surface of the cornice undercut 84 and the rest of the cornice portion 70. As depicted in FIG. 3A, the cornice undercut 84 can have a semi-circular or semi-oval cross-section. In other variations not shown in the figures but contemplated by the disclosure, the cornice undercut 84 can have a cross-section of different shapes, e.g. triangular or rectangular. The cornice undercut 84 can extend radially inward relative to or further inward than the frustum surface 76. For example, the semi-circular cutout of the cornice undercut 84 can extend radially inward relative to the frustum surface 76. The portion of the abutment assembly 44 defined by the cornice undercut 84 can be substantially shaped as a hyperboloid.

As shown in FIG. 3A, the frustum base 78 can adjoin a base undercut 86. The base undercut 86 can extend circumferentially around a perimeter of the frustum base 78. For example, the base undercut 86 can be a groove or indentation extending radially inward relative to the frustum surface 76. The base undercut 86 can have a semi-circular or semi-oval cross-section. In other variations not shown in the figures but contemplated by the disclosure, the base undercut 86 can have a cross-section of different shapes, e.g. triangular or rectangular. The portion of the abutment assembly 44 defined by the base undercut 86 can be substantially shaped as a hyperboloid.

The base undercut 86 can be located in between the frustum base 78 and the abutment ledge 72. The abutment ledge 72 can be a section of the upper abutment portion 54 closest to the lower abutment portion 56. The abutment ledge 72 can be the section of the upper abutment portion 54 furthest away or distal to the top of the abutment assembly 44.

In the variation shown in FIGS. 3A and 3B, the abutment ledge 72 can be substantially shaped as a compressed frustoconic. The abutment ledge 72 in combination with the lower abutment portion 56 can be substantially diamond-shaped where the abutment ledge 72 is shaped as the crown and girdle of the diamond and the lower abutment portion 56 is shaped as the pavilion of the diamond. The abutment ledge 72 can be the widest part of the abutment assembly 44 with the maximum transverse cross-sectional diameter of the abutment ledge 72 exceeding the transverse cross-sectional diameter of all other segments of the abutment assembly 44.

The abutment ledge 72 can comprise a ledge top surface 88 and a ledge lateral surface 90. The ledge top surface 88 can extend from and define part of the base undercut 86. The ledge top surface 88 can serve as a receiving surface for a bottom edge of the sleeve frame 50. The ledge top surface 88 can offer a surface aligned with the bottom edge of the sleeve frame 50. In one variation, the ledge top surface 88 can be a substantially horizontal surface transverse to the abutment assembly 44. In other variations, the ledge top surface 88 can be sloped or angled up to 80° relative to a horizontal transverse plane. The ledge top surface 88 can be a smooth surface or an abraded or friction-inducing surface.

The ledge lateral surface 90 can be defined by a receiving groove 92. The receiving groove 92 can extend circumferentially around the ledge lateral surface 90. For example, the receiving groove 92 can be a furrow, indentation, or cutout extending radially inward relative to the ledge lateral surface 90. The receiving groove 92 can have a semi-circular or semi-oval cross-section. In other variations, the receiving groove 92 can have a rectangular cross-section or a cross-section of another polygonal shape. The receiving groove 92 can be surrounded by a groove rim 94. The groove rim 94 can be portions of the ledge lateral surface 90 closest or proximal to the receiving groove 92.

As illustrated in FIG. 3A, the seal 46 can be positioned in the receiving groove 92. The seal 46 can be positioned in the receiving groove 92 in an uncompressed configuration 96. The uncompressed configuration 96 can refer to a physical state or configuration of the seal 46 when the seal 46 is not subject to compressive forces from the coping base 100 (FIG. 3B) when seated on the seal 46. The uncompressed configuration 96 can also refer to a physical state or configuration of the seal 46 when the seal 46 is not elastically deformed. As shown in FIG. 3A, the seal 46 can have a substantially circular cross-section when the seal 46 is placed in the receiving groove 92 in the uncompressed configuration 96. Also, as shown in FIG. 3A, the size of the receiving groove 92 (e.g., the cross-sectional size or the width of the receiving groove 92) can be greater than the size of the seal 46 (e.g., the diameter of the seal 46) when the seal 46 is positioned in the receiving groove 92 in the uncompressed configuration 96.

For example, as shown in FIG. 3A, at least part of the receiving groove 92 can be uncovered or unfilled by the seal 46 when the seal 46 is positioned in the receiving groove 92 in the uncompressed configuration 96. Moreover, at least a portion of the seal 46 can extend beyond or protrude past the groove rim 94 when the seal 46 is positioned in the receiving groove 92 in the uncompressed configuration 96.

FIG. 3B illustrates a cross-sectional side view of a variation of the coping 48 covering the abutment assembly 44. The coping 48 can comprise an inner surface 98 and a coping base 100. The inner surface 98 can be a surface of the underside of the coping 48. The inner surface 98 can be a tapered underside surface of the coping 48. The inner surface 98 of the coping 48 can be in contact with portions of the sleeve 42, the abutment assembly 44, or a combination thereof.

The coping base 100 can be a portion of the coping 48 shaped or configured to interface with or fit on the abutment ledge 72. The coping base 100 can be shaped substantially as an annular or disc-shaped protrusion extending radially outward, either at an angle, vertically, or horizontally, from the center of the coping 48. The coping base 100 can be the portion of the coping 48 furthest away or distal to the top or cap portion of the coping 48. The coping base 100 can be the widest part of the coping 48 with the maximum transverse cross-sectional diameter of the coping base 100 exceeding the maximum transverse cross-sectional diameter of the abutment assembly 44.

The coping base 100 can be in contact with at least a portion of the abutment ledge 72, including the ledge lateral surface 90, when the coping 48 is positioned on the abutment assembly 44. In addition, at least a portion of the exterior surface of the coping base 100 can be in contact with a part of the seal 46 when the coping 48 is positioned on the abutment assembly 44. The coping base 100 can congruently fit on top of the abutment ledge 72 to create a barrier against food particles or other oral debris from entering the interior of the coping 48.

The coping base 100 can compress or deform the seal 46 into a compressed configuration 102. The coping base 100, in combination with the surface of the receiving groove 92, can compress or deform the seal 46 from the uncompressed configuration 96 into the compressed configuration 102. The seal 46 can take on the shape of the receiving groove 92 when the seal 46 is in the compressed configuration 102. For example, the seal 46 can be compressed to have an oval or semi-oval shaped cross-section when the seal 46 is in the compressed configuration 102.

The seal 46 can partially fill or fill the entire volume of the receiving groove 92 when the coping 48 is placed on the abutment assembly 44 and the coping base 100 compresses the seal 46 into the compressed configuration 102. In addition, at least a portion of the seal 46 can extend or protrude beyond the groove rim 94 when the coping 48 is placed on the abutment assembly 44 and the coping base 100 compresses the seal 46 into the compressed configuration 102.

The seal 46 can serve as part of the barrier to prevent food particles or other oral debris from entering the interior of the coping 48 or reaching the frustum 58 of the abutment assembly 44.

The inner surface 98 of the coping 48 can be defined by a coping undercut 104. The coping undercut 104 can extend around the inner surface 98 of the coping 48. The coping undercut 104 can be a groove or indentation extending radially into the inner surface 98 of the coping 48. The coping undercut 104 can be defined along a lower portion of the coping 48 proximal to the coping base 100.

One or more locking flaps 52 of the sleeve 42 can project radially outward relative to the lateral surface of the sleeve frame 50 to lock against an edge or surface of the coping undercut 104. The radially outward projecting locking flaps 52 can be referred to as the outward flaps 106. The outward flaps 106 can lock against the edge or surface of the coping undercut 104 when the terminal ends of the outward flaps 106 pushes against or contacts the edge or surface of the coping undercut 104 when the coping 48 is placed on the upper abutment portion 54 of the abutment assembly 44. The outward flaps 106 can lock against the edge or surface of the coping undercut 104 to removably and adjustably couple the coping 48 to the abutment assembly 44. The outward flaps 106 can also lock against the edge or surface of the coping undercut 104 to prevent the coping 48 from being longitudinally displaced from the abutment assembly 44. The outward flaps 106 can lock against the edge or surface of the coping undercut 104 at the same time that the inward flaps 82 lock against the chamfered edge 80.

The seal 46 can be disposed in between the coping base 100 and the abutment ledge 72 to allow the coping 48 to translate relative to the abutment assembly 44. For example, the seal 46 can be disposed in between the coping base 100 and the abutment ledge 72 to allow the coping 48 to vertically translate relative to the abutment assembly 44. For example, the seal 46 can be disposed in between the coping base 100 and the abutment ledge 72 to allow the coping 48 to vertically translate between 1 μm and 100 μm relative to the abutment assembly 44 while the coping 48 is locked against the abutment assembly 44. In other variations, the seal 46 can allow the coping 48 to also horizontally translate relative to the abutment assembly 44.

The seal 46 can allow the coping 48 to translate relative to the abutment assembly 44 by elastically deforming from the uncompressed configuration 96 into the compressed configuration 102, and vice versa. For example, the seal 46 can absorb compressive energy applied to the seal 46 by the coping base 100 by first elastically deforming from the uncompressed configuration 96 into the compressed configuration 102 and then releasing that compressive energy by expanding or reforming, at least partially, into the uncompressed configuration 96.

In other variations, the seal 46 can allow the coping 48 to translate relative to the abutment assembly 44 by elastically deforming from a partially compressed configuration into a fully compressed configuration. Similar to the above, the seal 46 can absorb compressive energy applied to the seal 46 by the coping base 100 by first elastically deforming from a first compressed configuration into a second compressed configuration and then releasing that compressive energy by reversing, at least partially, the process by expanding or reforming from the second compressed configuration into the first compressed configuration.

The seal 46 can allow the coping 48, and the oral appliance 28 attached to the coping 48, to translate relative to the abutment assembly 44 to mimic the vertical physiological movement of natural teeth when a patient engages in mastication or other routine behavior involving the patient's dentition. The seal 46 can allow the oral appliance 28 and coping 48 to translate relative to the abutment assembly 44 when the oral appliance 28 and coping 48 are not fixedly attached to the abutment assembly 44 by cement or other permanent adhesives. For example, the seal 46 can allow the oral appliance 28 and coping 48 to translate vertically relative to the abutment assembly 44 when the abutment assembly 44 is coupled to the coping 48 and the oral appliance 28 via the sleeve 42.

FIGS. 4A and 4B illustrate perspective and side cross-sectional views, respectively, of a variation of the prosthesis assembly 40 with a seal 46 positioned on the abutment assembly 44. As shown in FIGS. 4A and 4B, the coping 48 can be defined by a grooved outer surface 108. The grooved outer surface 108 can include a plurality of indentations, furrows, or notches extending radially into the outer surface of the coping 48. The grooved outer surface 108 can allow the coping 48 to more easily attach to the oral appliance 28 via adhesives or cement.

FIG. 4A illustrates that the sleeve 42 can be positioned on the frustum 58 of the upper abutment portion 54 in a locking configuration 110. The sleeve 42 can be considered to be in the locking configuration 110 when one or more locking flaps 52 project or curve radially inward or outward relative to the lateral surface of the sleeve frame 50. The locking flaps 52 can include one or more inward flaps 82 and one or more outward flaps 106. One sleeve 42 can have both inward flaps 82 and outward flaps 106 arranged in an alternating manner. The locking flaps 52, including the inward flaps 82 and the outward flaps 106, can be slotted cut-outs defined along the lateral surface of the sleeve 42.

FIG. 4A shows that the inward flaps 82 can be connected to or contiguous with a lower portion of the sleeve frame 50. Also, the outward flaps 106 can be connected to or contiguous with an upper portion of the sleeve frame 50. In other variations not shown in the figures but contemplated by the disclosure, the inward flaps 82 can be connected to or contiguous with the upper portion of the sleeve frame 50 and the outward flaps 106 can be connected to or contiguous with the lower portion of the sleeve frame 50.

When the sleeve 42 is folded into a tapered or frustoconical shape, the diameter of the lower portion of the sleeve 42 can be greater than the diameter of the upper portion of the sleeve 42. FIG. 4A also illustrates that the sleeve 42 can have one or more gaps 112 defined along the upper portion of the sleeve frame 50. The gaps 112 can be spaces or non-contiguous regions along the upper portion of the sleeve frame 50. The gaps 112 can allow the sleeve 42 to more easily fold or curl into a tapered or frustoconical shape. The gaps 112 can be located along the same longitudinal segments as the inward flaps 82. In other variations, the gaps 112 can be located along the same longitudinal segments as the outward flaps 106.

FIG. 4A shows that each of the inward flaps 82 can be immediately adjacent to two outward flaps 106. In other variations, each of the outward flaps 106 can be arranged in between another outward flap 106 and an inward flap 82 or arranged in between two inward flaps 82.

FIG. 4B illustrates that the upper abutment portion 54 can have a height dimension 114 and a ledge diameter 116. The height dimension 114 of the upper abutment portion 54 can range from, e.g., 1.0 mm to 20.0 mm.

The ledge diameter 116 can be a maximum diameter of the abutment assembly 44 at the abutment ledge 72. The ledge diameter 116 can range from, e.g., 2 mm to 12 mm.

The sleeve 42 and abutment assembly 44 shown in FIGS. 4A and 4B can be used to secure an oral appliance 28 configured to replace a bicuspid, a cuspid, or an incisor. For example, the sleeve 42 and abutment assembly 44 shown in FIGS. 4A and 4B can be used to secure an oral appliance 28 configured to replace a second bicuspid. In other variations not shown in the figures, the sleeve 42 and abutment assembly 44 can be used to secure an oral appliance 28 configured to replace a molar.

The sleeve 42 can be fabricated from or comprise a shape memory material such as a shape memory metal or metal alloy, a shape memory polymer, or a composite thereof. In these and other variations, the sleeve 42 can be fabricated from or comprise stainless steel, nickel-titanium alloys such as Nitinol, titanium, or a composite thereof.

In one variation, the sleeve 42 can have eight total locking flaps 52 with four inward flaps 82 and four outward flaps 106. In another variation, the sleeve 42 can have nine total locking flaps 52 with three inward flaps 82 and six outward flaps 106. The locking flaps 52 can be arranged so that each inward flap 82 is adjacent to two outward flaps 106 and each outward flap 94 adjacent to one inward flap 82 and one other outward flap 94.

Another variation of the sleeve 42 can have nine total locking flaps 52 with three inward flaps 82 and six outward flaps 106. The locking flaps 52 can be arranged so that each inward flap 82 is adjacent to two outward flaps 106 and each outward flap 94 adjacent to one inward flap 82 and one other outward flap 94.

Although several variations of the sleeve 42 having different number and arrangement of locking flaps 52 are shown, it should be understood by one of ordinary skill in the art that other variations of the sleeve 42 are contemplated by this disclosure including sleeves 42 having less than eight locking flaps 52 or more than nine locking flaps 52. In addition, it is contemplated by this disclosure that the locking flaps 52 of the sleeve 42 can have differing length dimensions. For example, all of the locking flaps 52 of a singular sleeve 42 can have a different length dimension and none of the locking flaps 52 of this singular sleeve 42 can be of the same or equivalent lengths. One benefit of the sleeve 42 having locking flaps 52 of differing lengths is to provide tolerance for mistakes committed by the dental practitioner in placing the oral appliance 28 onto the abutment assembly 44.

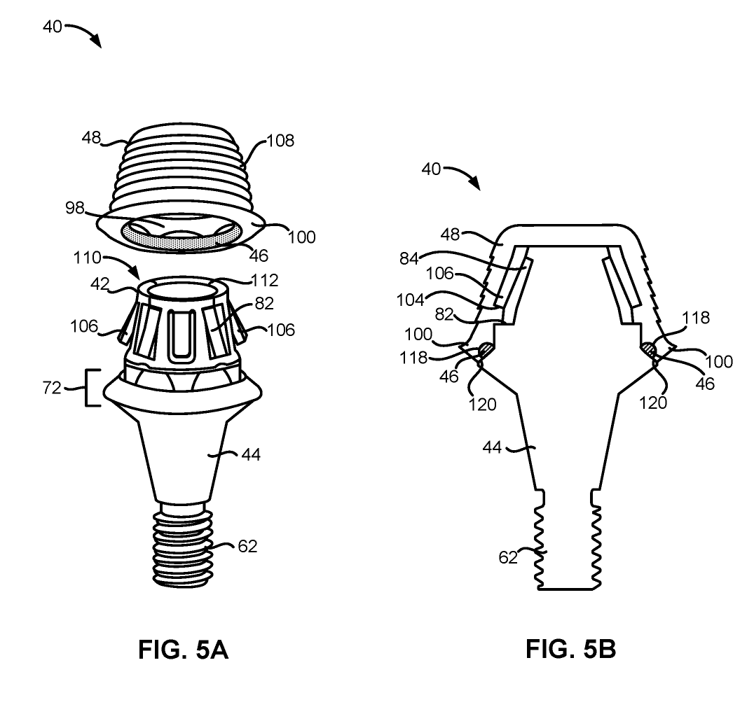

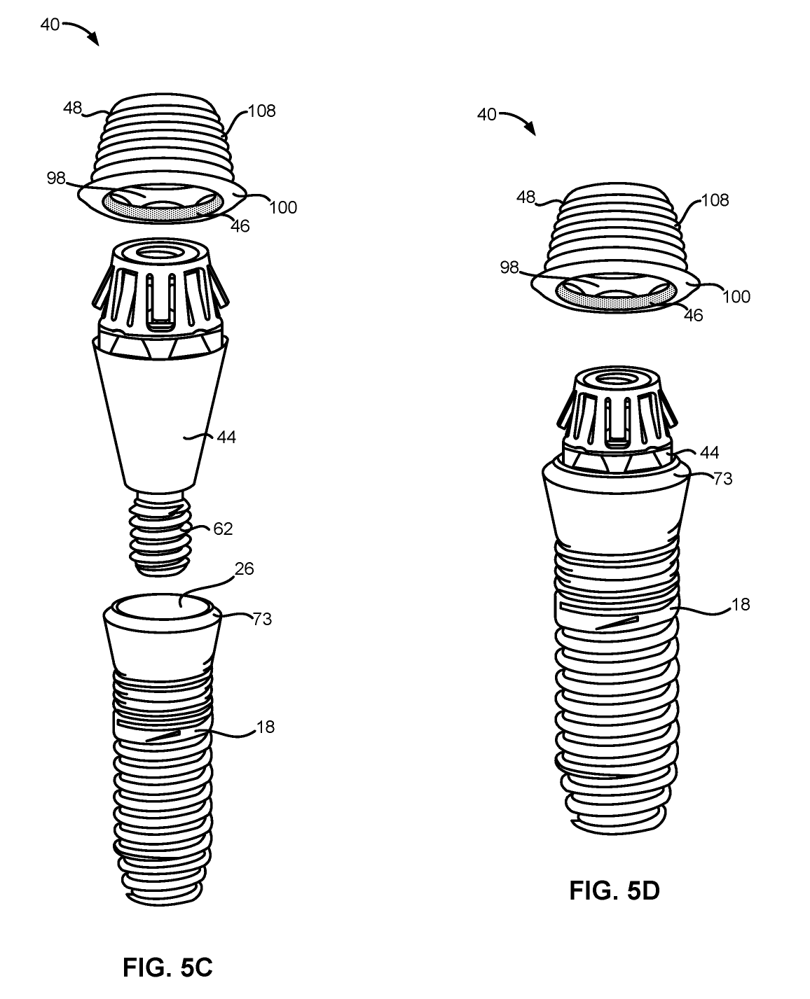

FIGS. 5A and 5B illustrate perspective and side cross-sectional views, respectively, of a variation of the prosthesis assembly 40 with the seal 46 positioned in the coping 48. As shown in FIG. 5B, the inner surface 98 of the coping base 100 can be defined by a receiving groove 118. The receiving groove 118 can be a furrow, indentation, or cutout extending radially inward relative to the inner surface 98 of the coping base 100. The receiving groove 118 can have a semi-circular or semi-oval cross-section. In other variations, the receiving groove 118 can have a rectangular cross-section or a cross-section of another polygonal shape. The receiving groove 118 can be surrounded by a groove rim 120. The groove rim 120 can be portions of the inner surface 98 of the coping base 100 adjoining the receiving groove 118.

As illustrated in FIGS. 5A and 5B, the seal 46 can be positioned in the receiving groove 118. The seal 46 can be positioned in the receiving groove 118 in an uncompressed configuration 96. The size of the receiving groove 118 (e.g., the cross-sectional size or the width of the receiving groove 118) can be greater than the size of the seal 46 when the seal 46 is positioned in the receiving groove 118 in the uncompressed configuration 96.

At least part of the receiving groove 118 can be uncovered or unfilled by the seal 46 when the seal 46 is positioned in the receiving groove 118 in the uncompressed configuration 96. Moreover, at least a portion of the seal 46 can extend beyond or protrude past the groove rim 120 when the seal 46 is positioned in the receiving groove 118 in the uncompressed configuration 96.

The abutment ledge 72, including the ledge lateral surface 90, can compress or deform the seal 46 into the compressed configuration 102. The ledge lateral surface 90, in combination with the surface of the receiving groove 118, can compress or deform the seal 46 from the uncompressed configuration 96 into the compressed configuration 102. The seal 46 can take on the shape of the receiving groove 118 when the seal 46 is in the compressed configuration 102. For example, the seal 46 can be compressed to have an oval or semi-oval shaped cross-section when the seal 46 is in the compressed configuration 102.

The seal 46 can fill the entire volume of the receiving groove 118 when the coping 48 is placed on the abutment assembly 44 and the ledge lateral surface 90 compresses the seal 46 into the compressed configuration 102. In addition, at least a portion of the seal 46 can extend or protrude beyond the groove rim 120 when the coping 48 is placed on the abutment assembly 44 and the ledge lateral surface 90 compresses the seal 46 into the compressed configuration 102.

The seal 46, when disposed in between the coping base 100 and the abutment ledge 72, can allow the coping 48 to translate relative to the abutment assembly 44 by elastically deforming from the uncompressed configuration 96 into the compressed configuration 102, and vice versa. For example, the seal 46 can absorb compressive energy applied to the seal 46 by either the coping base 100 or the ledge lateral surface 90 by first elastically deforming from the uncompressed configuration 96 into the compressed configuration 102 and then releasing that compressive energy by expanding, at least partially, into the uncompressed configuration 96.

In other variations, the seal 46 can allow the coping 48 to translate relative to the abutment assembly 44 by elastically deforming from a partially compressed configuration 102 into a fully compressed configuration 102. Similar to the above, the seal 46 can absorb compressive energy applied to the seal 46 by either the coping base 100 or the ledge lateral surface 90 by first elastically deforming from a first compressed configuration into a second compressed configuration and then releasing that compressive energy by reversing, at least partially, the process by expanding from the second compressed configuration into the first compressed configuration.

FIG. 5C illustrates yet another variation of the prosthesis assembly 40 having an implant 18 with an implant ledge 73. As shown in FIG. 5C, lower abutment portion of the abutment assembly 44 can be positioned within the receiving well 26 of the implant 18. The implant ledge 73, similar to the abutment ledge 72 of FIG. 5A, can compress or deform the seal 46 into the compressed configuration 102.

FIG. 5D illustrates the prosthesis assembly 40 with the abutment assembly 44 positioned within the receiving well 26 of the implant 18. As shown in FIGS. 5C and 5D, the inner surface 98 of the coping base 100 can be defined by a receiving groove and the seal 46 can be positioned in the receiving groove. When the coping 48 is placed on the abutment assembly 44, the seal 46 can be compressed into the compressed configuration. The seal 46, when disposed in between the coping base 100 and the implant ledge 73, can allow the coping 48 to translate relative to the implant 18 and the abutment assembly 44 by elastically deforming from the uncompressed configuration into the compressed configuration, and vice versa. For example, the seal 46 can absorb compressive energy applied to the seal 46 by either the coping base 100 or the implant ledge 73 by first elastically deforming from the uncompressed configuration into the compressed configuration and then releasing that compressive energy by expanding, at least partially, into the uncompressed configuration.

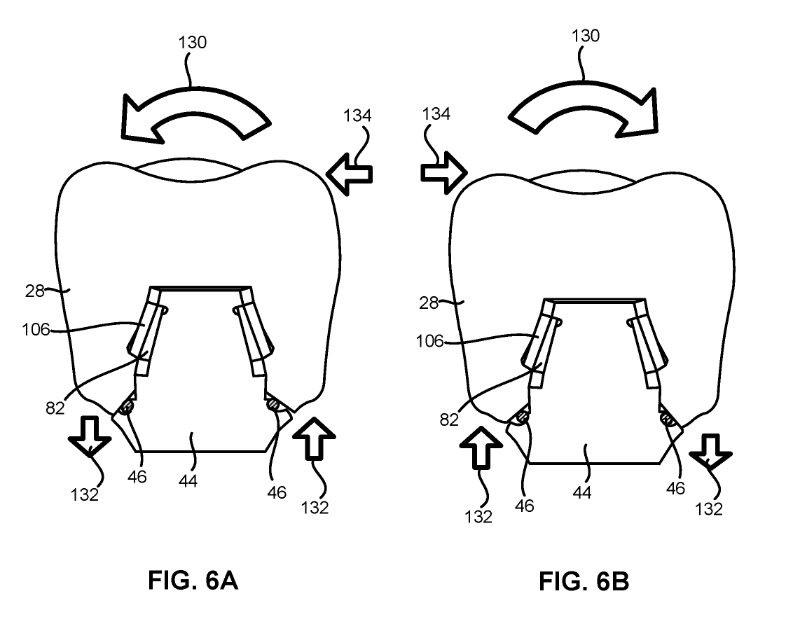

FIGS. 6A and 6B illustrate cross-sectional side views of a variation of the oral appliance 28 mimicking the physiological movements of natural teeth on the abutment assembly 44. The seal 46 can allow the oral appliance 28, and the coping 48 attached thereto, to translate relative to the abutment assembly 44 in one or more movements 130. The movements 130 can include small or subtle movements or translations in one or more coronoapical or occlusoapical directions 132, mesiodistal directions 134, or a combination thereof. The seal 46 can allow the oral appliance 28, and the coping 48 attached thereto, to translate up or down and/or left or right on the abutment assembly 44 to mimic the subtle physiological movements of a patient's natural teeth.

The seal 46 can elastically deform or reform to allow the oral appliance 28, and coping 48 attached thereto, to vertically translate or translate in the occlusoapical direction 132 between, e.g., 1 μm and 100 μm relative to the abutment assembly 44, such as relative to the ledge lateral surface 90 of the abutment assembly 44. In some variations, the seal 46 can also elastically deform or reform to allow the oral appliance 28, and coping 48 attached thereto, to horizontally/laterally translate or translate in the mesiodistal direction 134 between 1 μm and 100 μm relative to the abutment assembly 44.

For example, as illustrated in FIG. 6A, the patient can apply a compressive force to one part of the oral appliance 28 in the apical direction while another part of the same oral appliance 28 is vertically translated in the coronal direction as a result. In this case, the coping base 100 at the compression site can elastically deform one portion of the seal 46 into a partial or fully compressed configuration 102. At the same time, the portion of the seal 46 diametrically opposed to the compressed portion of the seal 46 can elastically expand or reform as the coping base 100 previously in contact with this portion of the seal 46 is vertically translated or lifted up in the coronal direction relative to the ledge lateral surface 90 as a result of the compressive forces applied to the other part of the oral appliance 28. This translation of one part of the oral appliance 28 and coping 48 in the coronal direction and another part of the oral appliance 28 and coping 48 in the apical direction can cause a translation of the oral appliance 28 in a lateral or horizontal direction, such as a distal direction. FIG. 6B illustrates that the oral appliance 28 can also translate in the mesial direction as a different part of the oral appliance 28 is subjected to compressive forces.

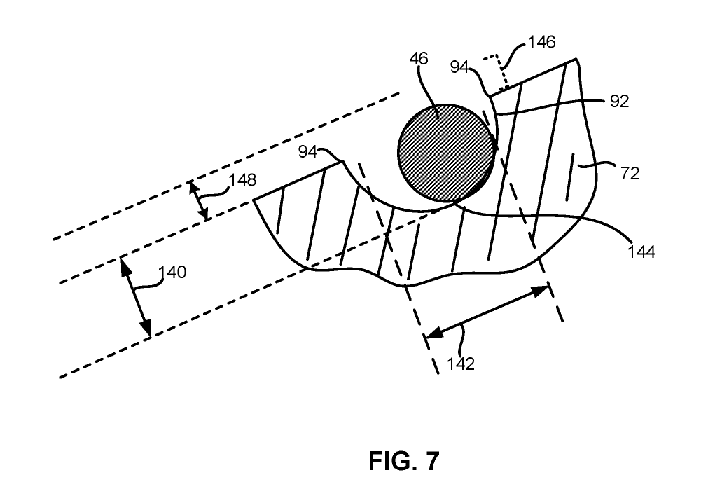

FIG. 7 illustrates a close-up of a cross-sectional view of a variation of the seal 46 in the receiving groove 92. FIG. 7 shows that the receiving groove 92 can be defined by a groove depth 140 and a groove width 142. The groove depth 140 can be measured from a nadir 144 or lowest position of the receiving groove 92 to the groove rim 94. In some variations, the groove depth 140 can be between, e.g., 0.1 mm and 2.0 mm.

The groove width 142 can be measured from one groove rim 94 to the other groove rim 94 surrounding or bounding the receiving groove 92. For example, the groove width 142 can be measured from one groove rim 94 to another groove rim 94 radially inward or outward from the one groove rim 94. In some variations, the groove width 142 can be between, e.g., 0.1 mm and 2.0 mm.

FIG. 7 also illustrates that the seal 46 can have a protruding portion 146. The protruding portion 146 can be the portion of the seal 46 protruding or extending beyond the groove rim 94 when the seal 46 is positioned or seated in the receiving groove 92. The protruding portion 146 of the seal 46 can be measured by a protrusion height 148. The protrusion height 148 can be measured from the groove rim 94 to the top or apex of the protruding portion 146. The protrusion height 148 can be between, e.g., 0.02 mm and 2.00 mm.

Although FIG. 7 shows the groove depth 140, groove width 142, and protrusion height 148 of the seal 46 positioned in the receiving groove 92 defined along the abutment ledge 72, it is contemplated by this disclosure that the same groove depth 140, groove width 142, and protrusion height 148 can also represent the seal 46 positioned in the receiving groove 118 defined along the inner surface 98 of the coping base 100.

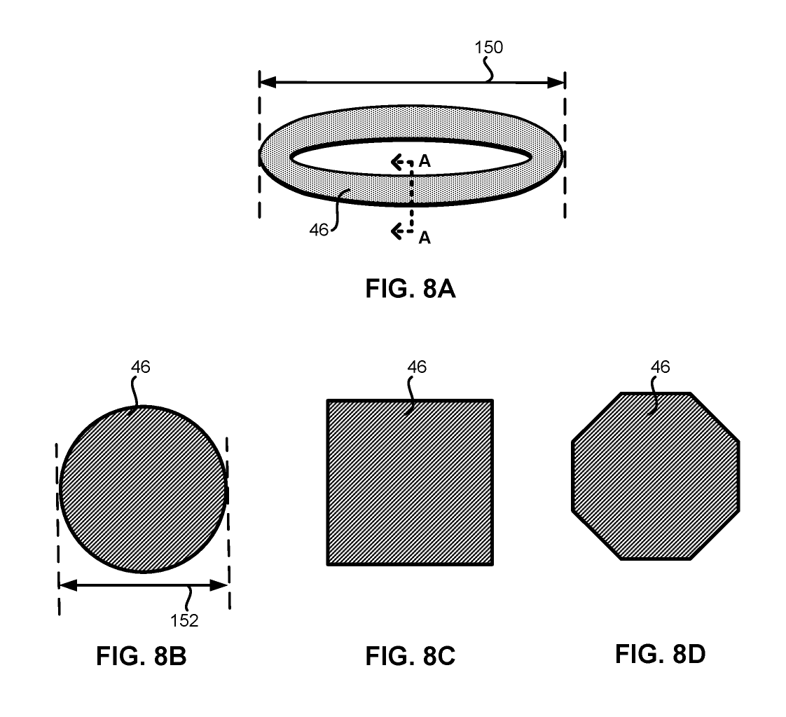

FIG. 8A illustrates a perspective view of a variation of the seal 46. The seal 46 can have a seal body diameter 150 and a seal cross-sectional diameter 152 as shown in FIG. 8B. The seal body diameter 150 can be the diameter of the entire seal 46 when the seal 46 is substantially shaped as an annulus or torus. In some variations, the seal body diameter 150 can be between, e.g., 2.0 mm and 10.0 mm.

The seal 46 can also have a seal cross-sectional diameter 152 as shown in FIG. 8B. The seal 46 can have a seal-cross-sectional diameter 152 when the seal 46 has a substantially circular cross-section. The seal cross-sectional diameter 152 can be between, e.g., 0.10 mm to 2.0 mm.

The seal 46 can be fabricated from any number of biocompatible elastomers, e.g., silicone, polyurethane, poly(vinyl chloride), etc. The seal 46 can comprise an elastomeric material having a Shore hardness of between, e.g., 10 A and 100 A.

FIG. 8C illustrates a cross-section of a variation of the seal 46 taken along the same line A-A as shown in FIG. 8A. The seal 46 in this variation can have a substantially rectangular cross-section. The seal 46 can be shaped as a toroid having a substantially rectangular cross-section. The seal 46 can also be shaped as a substantially cuboidal seal having four connected rectangular prisms as sides.

FIG. 8D illustrates a cross-section of another variation of the seal 46 taken along the same line A-A as shown in FIG. 8A. The seal 46 in this variation can have a substantially octagonal cross-section. The seal 46 can be shaped as a toroid having a substantially octagonal cross-section. In other variations not shown in FIGS. 8A-8D but contemplated by this disclosure, the seal 46 can have a hexagonal, decagonal, or dodecagonal cross-section and the seal 46 can be a toroid having such a cross-section.

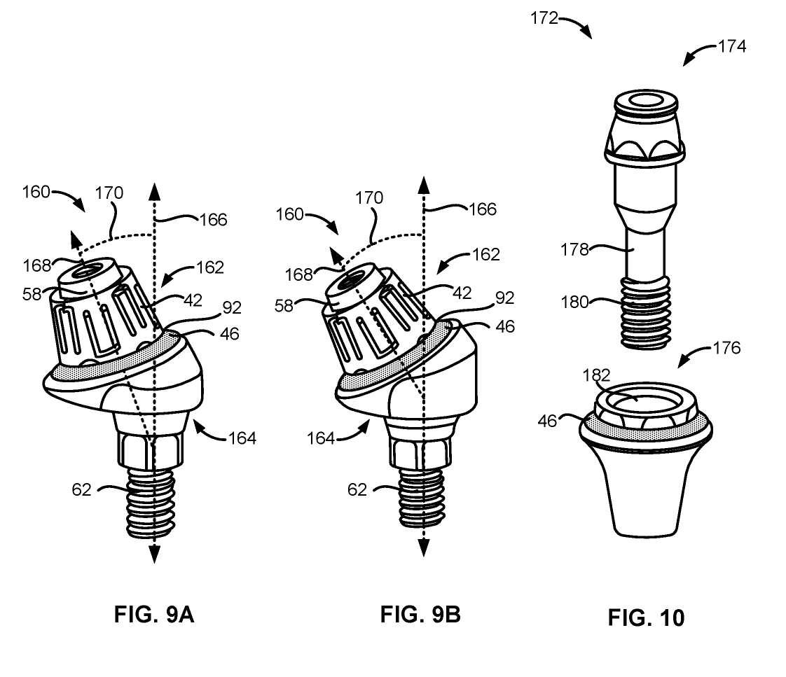

FIGS. 9A and 9B illustrate variations of an angled abutment assembly 160 with the seal 46 positioned on the angled abutment assembly 160. The angled abutment assembly 160 can comprise an upper abutment portion 162 and a lower abutment portion 164. The lower abutment portion 164 can comprise a threaded pin 62. The threaded pin 62 can be inserted or screwed into a threaded cavity of the implant 18 to secure the angled abutment assembly 160 to the implant 18. FIGS. 9A and 9B also illustrate a thread longitudinal axis 166 and a frustum longitudinal axis 168. The thread longitudinal axis 166 and the frustum longitudinal axis 168 can be used to orient the angled abutment assembly 160. The thread longitudinal axis 166 can run along the length of the threaded pin 62 and the frustum longitudinal axis 168 can run along the length of the frustum 58. The upper abutment portion 162 can be angled relative to the lower abutment portion 164. For example, the frustum 58 of the angled abutment assembly 160 can be angled relative to the thread 62 of the angled abutment assembly 160. More specifically, the thread longitudinal axis 166 can form an angle 170 with respect to the frustum longitudinal axis 168.

The upper abutment portion 162 can also be defined by the receiving groove 92. The seal 46 can be positioned in the receiving groove 92 to serve as an interface layer or cushioning layer between the coping 48 and the angled abutment assembly 160.

The angle 170 can range from 1° to 60°. For example, the angled abutment assembly 160 of FIG. 9A can have an angle 170 of approximately 17° and the angled abutment assembly 160 of FIG. 9B can have an angle 170 of approximately 30°. The angle 170 can vary depending on the desired angulation of the oral appliance 28 relative to the implant 18.

FIGS. 9A and 9B illustrate that the frustum 58 of the angled abutment assembly 160 can be covered by the sleeve 42. For example, any of the sleeves 42 depicted in FIG. 2, 3A, 3B, 4A, 4B, 5A, or 5B can be positioned on the frustum 58 to lock an oral appliance 28 to the angled abutment assembly 160 via a coping 48 attached to the oral appliance 28.

The angled abutment assembly 160 can be fabricated from the same material(s) as the abutment assembly 44 including any number of biocompatible materials, e.g., metals, metal alloys, polymers, or composites thereof.

FIG. 10 illustrates a variation of a two-piece abutment assembly 172 with a seal 46 positioned on the two-piece abutment assembly 172. The two-piece abutment assembly 172 can comprise an upper abutment portion 174 and a lower abutment portion 176. The upper abutment portion 174 can also be defined by the receiving groove 92. The seal 46 can be positioned in the receiving groove 92 to serve as an interface layer or cushioning layer between the coping 48 and the upper abutment portion 174 of the two-piece abutment assembly 172.

The upper abutment portion 174 can comprise an extender shaft 178 and an extension threaded portion 180. The extender shaft 178 can raise the height of the remainder of the upper abutment portion 174 to account for differences in the topography of the gingiva 14 of patients. The lower abutment portion 176 can comprise a receiving cavity 182. The receiving cavity 182 can be a threaded cavity for receiving the extension threaded portion 180. The lower abutment portion 176 can also comprise a threaded pin for coupling to the implant 18.

The two-piece abutment assembly 172 can be fabricated from the same material(s) as the abutment assembly 44 or the angled abutment assembly 160 including any number of biocompatible materials, e.g., metals, metal alloys, polymers, or composites thereof.

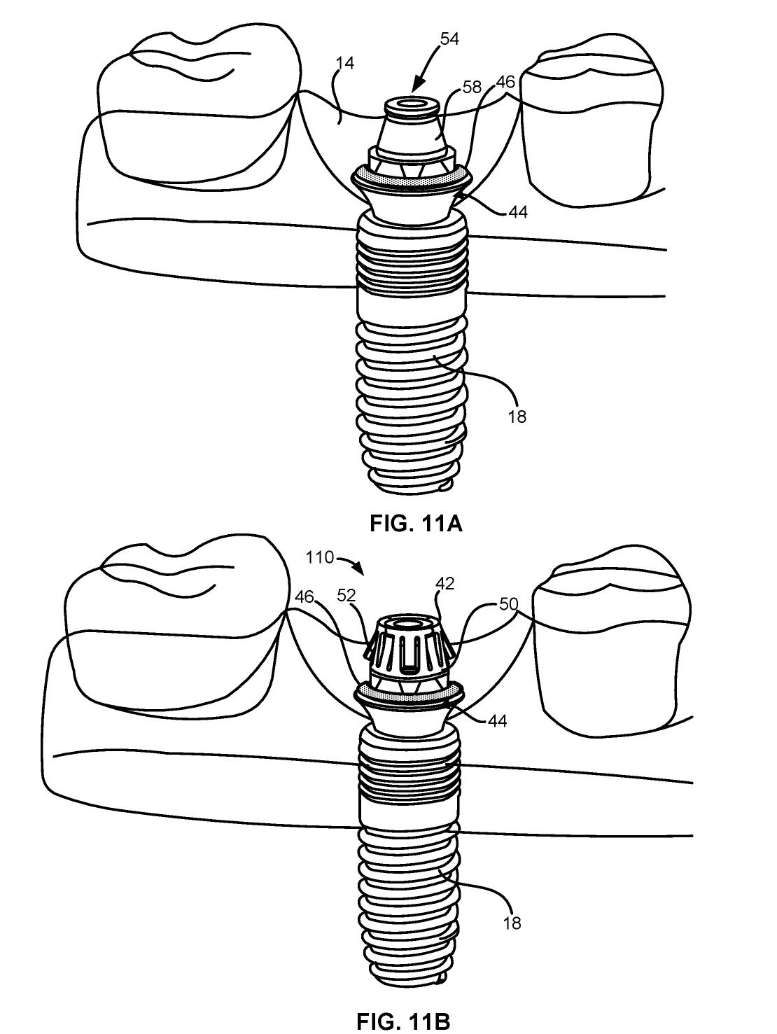

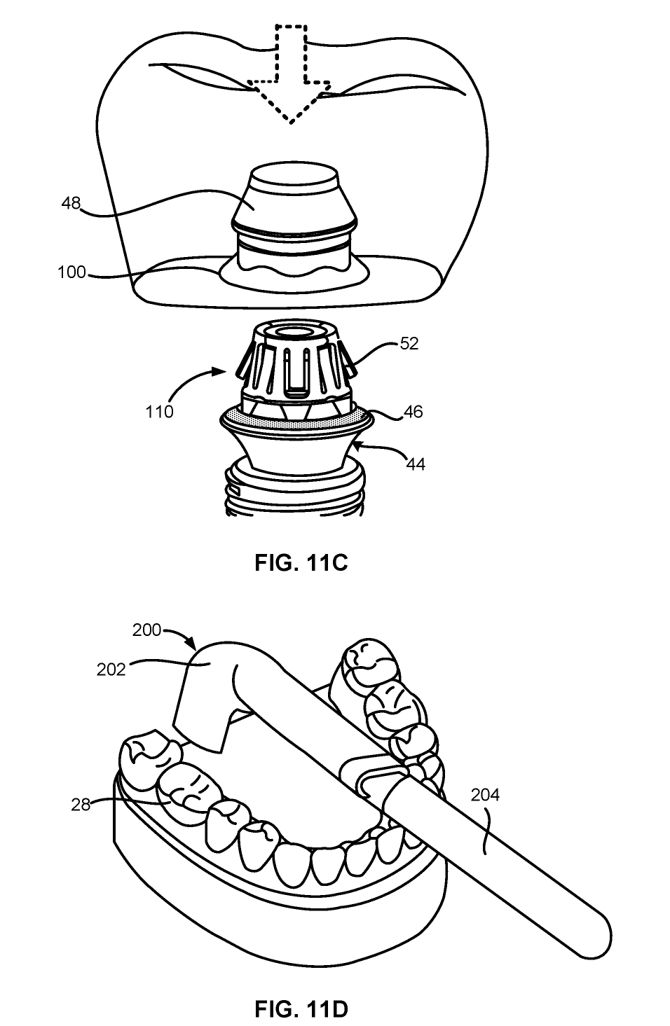

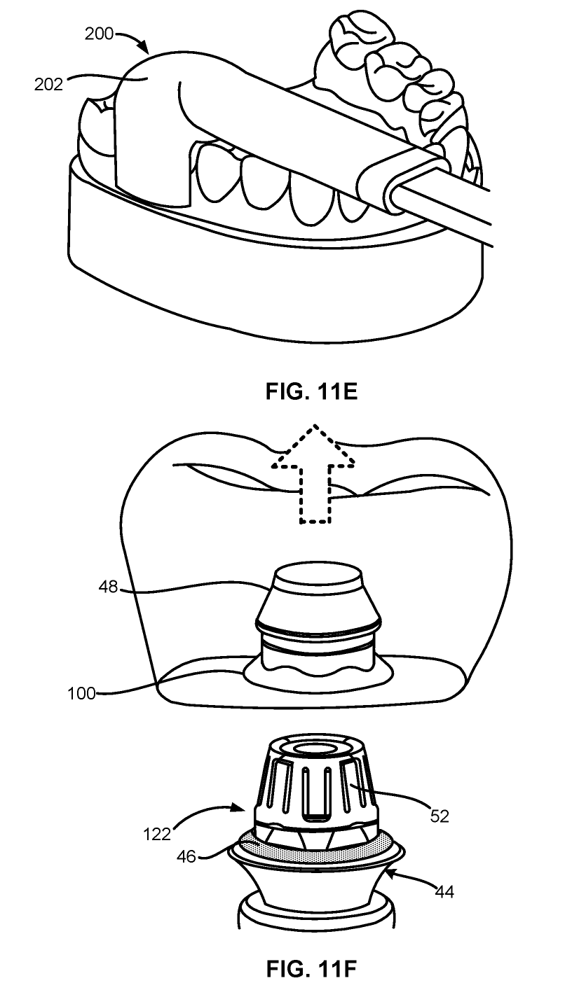

FIGS. 11A to 11F illustrate a method of placing and removing an oral appliance 28 from a variation of the abutment assembly 44 with the seal 46 positioned on the abutment assembly 44. FIG. 11A illustrates that an abutment assembly 44 can be coupled to an anchoring implant 18 implanted within an oral cavity of a patient. At least part of the abutment assembly 44 can extend beyond the gingiva 14 of the patient once the abutment assembly 44 is coupled to the anchoring implant 18. The abutment assembly 44 can have an upper abutment portion 54 defined by a receiving groove 92. The seal 46 can be positioned in the receiving groove 92 prior to placement or positioning of the sleeve 42.

FIG. 11B illustrates that a variation of the sleeve 42 can be coupled to the abutment assembly 44. The sleeve 42 can be any of the sleeves 42 depicted in FIG. 2, 3A, 3B, 4A, 4B, 5A, or 5B. For example, the sleeve 42 can have locking flaps 52 of differing lengths such as the locking flaps 52 depicted in FIG. 3A, 3B, 4A, 4B, 5A, or 5B. In the example variation shown in FIG. 11B, the sleeve 42 can be positioned on the frustum 58 of the abutment assembly 44 in the locking configuration 110. In this variation, the one or more inward flaps 82 can project radially inward relative to the sleeve frame 50. The inward flaps 82 can lock against chamfered edge 80 of the abutment assembly 44. The bottom edge of the sleeve frame 50 can also push against the base edge 186 of the abutment assembly 44 to couple or secure the sleeve 42 to the abutment assembly 44. FIG. 11B also illustrates that one or more outward flaps 106 can project radially outward relative to the sleeve frame 50 when the sleeve 42 is in the locking configuration 110.

FIG. 11C illustrates that an oral appliance 28, e.g., a crown, coupled to a coping 48 can be placed onto the sleeve 42 in the locking configuration 110 to secure the oral appliance 28 to the abutment assembly 44. The outward flaps 106 of the sleeve 42 can lock against the inner edge of the coping undercut 104 to prevent the oral appliance 28 from being vertically displaced from the abutment assembly 44. In addition, the anti-rotation mechanism 60 of the abutment assembly 44 can prevent the angular rotation of the oral appliance 28 while the oral appliance 28 is locked to the abutment assembly 44. At least a portion of the coping base 100 can contact or interface with the seal 46 when the coping 48 and the oral appliance 28 are positioned on the abutment assembly 44 and locked to the abutment assembly 44 via the sleeve 42.

FIG. 11D illustrates an actuator unit 200 in the process of being deployed on the oral appliance 28 coupled to the abutment assembly 44 by the sleeve 42. The actuator unit 200 can be a handheld or portable unit. The actuator unit 200 can comprise an actuator head 202 and an actuator shaft 204. The actuator unit 200 can also comprise a power source not shown in the figures.

FIG. 11E illustrates the actuator head 202 of the actuator unit 200 placed over the oral appliance 28. The actuator unit 200 can comprise an inductive heating assembly comprising a controller-like variable output oscillator circuit, a conductor, and one or more coils set apart in apposition and at a distance from one another. The controller-like variable output oscillator circuit can be coupled to the conductor and the coils. The distance or gap between the coils can define a receiving channel which can be sized to be positioned over an oral appliance 28, e.g., the crown shown in FIGS. 11C and 11F. When the abutment assembly 44, the sleeve 42, and the oral appliance 28 is positioned within the receiving channel of the actuator head 202, the controller-like variable output oscillator circuit can send an alternating current through the conductor to the coils to generate an alternating magnetic field between the coils. The alternating magnetic field can cause eddy currents to form in at least part of the abutment assembly 44, the coping 48, the sleeve 42, or a combination thereof. The eddy currents can cause at least part of the abutment assembly 44, the coping 48, the sleeve 42, or a combination thereof to heat up, thereby activating the shape memory material of the locking flaps 52 to initiate their shape change and cause the sleeve 42 to actuate into the low-profile configuration 122 of FIG. 11F.

The frequency of the alternating current and the magnetic field can be set between, e.g., 1 kHz and 1 MHz, depending on the size and configuration of the locking flaps 52 and the activation time. The power consumption can range between, e.g., 10 W to 5 kW. The induction heating assembly can be the induction heating assembly described in U.S. Pat. No. 9,168,111, which is herein incorporated by reference in its entirety. The actuator head 202 can also comprise a disposable or one-time use tip for covering or protecting the actuator head 202. As illustrated in FIG. 11F, once the sleeve 42 is actuated into the low-profile configuration 122, the coping 48 coupled to the oral appliance 28 can be uncoupled from the abutment assembly 44 and the oral appliance 28 can be lifted off of the abutment assembly 44.

The applications of the devices and methods discussed above are not limited to the securement of crowns, bridges, or dentures but may include any number of further treatment applications where the securement and adjustability of devices within a patient may be utilized. Moreover, such devices and methods may be applied to other treatment sites within the body. Modification of the above-described assemblies and methods for carrying out the disclosure, combinations between different variations as practicable, and variations of aspects of the invention that are obvious to those of skill in the art are intended to be within the scope of the claims.

Each of the individual variations or embodiments described and illustrated herein has discrete components and features which may be readily separated from or combined with the features of any of the other variations or embodiments. Modifications may be made to adapt a particular situation, material, composition of matter, process, process act(s) or step(s) to the objective(s), spirit or scope of the present invention.

Methods recited herein may be carried out in any order of the recited events that is logically possible, as well as the recited order of events. For example, the methods disclosed do not require the particular order described to achieve the desired result. Moreover, additional steps or operations may be provided or steps or operations may be eliminated to achieve the desired result.

It will be understood by one of ordinary skill in the art that all or a portion of the methods disclosed herein may be embodied in a non-transitory machine readable or accessible medium comprising instructions readable or executable by a processor or processing unit of a computing device or other type of machine.

Where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present disclosure (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this disclosure belongs.

This disclosure is not intended to be limited to the scope of the particular forms set forth, but is intended to cover alternatives, modifications, and equivalents of the variations or embodiments described herein. Further, the scope of the disclosure fully encompasses other variations or embodiments that may become obvious to those skilled in the art in view of this disclosure.

What is claimed is:

1. A securement assembly for retaining a dental prosthesis, comprising:
an abutment assembly comprising an upper abutment portion configured to extend beyond the gingiva of a patient, wherein the upper abutment portion comprises an abutment ledge and the abutment ledge is defined by a receiving groove;
a coping attached to the abutment assembly, wherein the coping comprises a coping base; and
a seal positioned in the receiving groove and in between at least the abutment ledge and the coping base, wherein the seal is configured to elastically deform to allow the coping to translate relative to the abutment assembly while the coping is locked against the abutment assembly.

2. The securement assembly of claim 1, wherein the seal is toroidal-shaped.

3. The securement assembly of claim 2, wherein the seal comprises a seal cross-sectional diameter of between 0.1 mm and 2.0 mm.

4. The securement assembly of claim 1, wherein the seal comprises silicone.

5. The securement assembly of claim 1, wherein the seal comprises an elastomeric material having a Shore hardness of between 10 A and 100 A.

6. The securement assembly of claim 1, wherein the seal is configured to elastically deform to allow the coping to translate vertically between 1 μm and 100 μm relative to the abutment assembly.

7. The securement assembly of claim 1, wherein the receiving groove comprises a groove rim and at least a portion of the seal protrudes beyond the groove rim when the seal is positioned in the receiving groove.

8. The securement assembly of claim 1, wherein the receiving groove has a groove depth of between 0.10 mm and 2.00 mm.

9. The securement assembly of claim 1, further comprising a sleeve covering at least part of the upper abutment portion, wherein the sleeve comprises one or more locking flaps to attach the coping to the abutment assembly.

10. The securement assembly of claim 9, wherein the coping comprises an inner surface and the inner surface is defined by an undercut and the one or more locking flaps of the sleeve project radially outward to lock against the undercut.

11. A securement assembly for retaining a dental prosthesis, comprising:
an abutment assembly comprising an upper abutment portion configured to extend beyond the gingiva of a patient, wherein the upper abutment portion comprises an abutment ledge;
a coping attached to the abutment assembly, wherein the coping has a coping base and an interior surface of the coping base is defined by a receiving groove; and
a seal positioned in the receiving groove and in between at least the abutment ledge and the coping base, wherein the seal is configured to elastically deform to allow the coping to translate relative to the abutment assembly while the coping is locked against the abutment assembly.

12. The securement assembly of claim 11, wherein the seal is toroidal-shaped.

13. The securement assembly of claim 12, wherein the seal comprises a seal cross-sectional diameter of between 0.1 mm and 2.0 mm.

14. The securement assembly of claim 11, wherein the seal comprises an elastomeric material having a Shore hardness of between 10 A and 100 A.

15. The securement assembly of claim 11, wherein the seal is configured to elastically deform to allow the coping to translate vertically between 1 μm and 100 μm relative to the abutment assembly.

16. The securement assembly of claim 11, wherein the receiving groove comprises a groove rim and at least a portion of the seal protrudes beyond the groove rim when the seal is positioned in the receiving groove.

17. The securement assembly of claim 11, wherein the receiving groove has a groove depth of between 0.10 mm and 2.00 mm.

18. A method of adjustably retaining an oral appliance in an oral cavity, comprising:
securing an abutment assembly comprising an upper abutment portion in an oral cavity of a patient such that the upper abutment portion extends beyond the gingiva of the patient, wherein the upper abutment portion comprises an abutment ledge and the abutment ledge is defined by a receiving groove;
positioning a seal in the receiving groove;
coupling a sleeve comprising one or more locking flaps to the upper abutment portion;
placing the oral appliance upon the upper abutment portion such that the seal is positioned in between the abutment ledge and a coping attached to the oral appliance, wherein the one or more locking flaps project radially outward to lock the oral appliance to the abutment assembly.

19. The method of claim 18, wherein the seal is configured to elastically deform to allow the coping to translate vertically between 1 μm and 100 μm relative to the abutment assembly.

20. The method of claim 18, wherein the receiving groove comprises a groove rim and at least a portion of the seal protrudes beyond the groove rim when the seal is placed in the receiving groove.
